(19) United States
(12) Patent Application Publication
(10) Pub. No.: US 2008/0082926 A1
(43) Pub. Date: Apr. 3, 2008

(54) Visual fragrance for UI

(75) Inventor: Erika Reponen, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/540,965

(22) Filed: Oct. 2, 2006

(51) Int. Cl. G06F 3/00

(52) U.S. Cl. 715/744

(57) ABSTRACT

A method for a user interface is disclosed. The method comprises providing a plurality of items on in a display view; determining a theme comprising a fashion indicator; and providing a visual effect associated with said fashion indicator in said display view. A user interface, an apparatus, a computer program, and a system for implementing the method is also disclosed.

### TECHNICAL FIELD

The present invention relates to a method for a user interface, a user interface, an apparatus, a computer program, and a system.

### BACKGROUND OF THE INVENTION

Portable electronic devices becomes more and more a gadget for expressing oneself in a social environment. This puts higher demands on making the apparatus user-configurable. US 2006/0032138 A1 discloses a mobile communication terminal with enhanced menu effects using a menu effect layer for allowing increased visibility of selected menu items. However, there is still a need for personalizing portable electronic devices.

### SUMMARY OF THE INVENTION

In view of the above, an objective of the invention is to solve or at least reduce the problems discussed above. In particular, an objective is to provide themes in an improved manner.

According to a first aspect of the present invention, there is provided a method for a user interface, comprising providing a plurality of items on in a display view; determining a theme comprising a fashion indicator; and providing a visual effect associated with said fashion indicator in said display view.

The fashion indicator may be a visual fragrance.

The provision of said visual effect may comprise providing an effect layer among said items.

The method may further comprise making said visual effect appear according to a predetermined appearing rule; and after said visual effect has been present for a predetermined time, making said visual effect disappear according to a predetermined disappearing rule. The appearing rule may be any of the group comprising spraying, painting, drawing, fuming, exploding, burning, raining, snowing, and growing. The disappearing rule may be any of the group comprising melting, splashing, boiling, burning, falling, fading, blowing, vaporizing, erasing, and smudging.

The items may be any mix from the user interface component group comprising an icon, a list item, a menu item, a file item, a symbol, a help function item, a scroll bar, a selection bar, a selection frame, and a status message item.

The method may further comprise receiving said theme and determining parameters from said theme on said visual effects. Acquiring said theme may further comprise buying said theme from a theme service provider, or receiving it from another peer entity.

The method may further comprise composing said theme. Composing said theme may comprise setting parameters for said visual effects.

The method may comprise transmitting said theme to another peer entity.

According to a second aspect of the present invention, there is provided a user interface comprising a display arranged to display a display view with a plurality of displayed items; and a theme handler arranged to arrange said display view according to a theme comprising a fashion indicator, wherein the arrangement of said display view comprises provision of a visual effect illustrating said fashion indicator.

The theme handler may be arranged to receive said theme and determine parameters from said theme among said visual effects. The theme may be received by buying said theme from a theme service provider.

The user interface may further comprise input means arranged to receive user input; and a theme composer arranged to generate said theme upon said user input. The user input may comprise parameters for said visual effects.

According to a third aspect of the present invention, there is provided an apparatus comprising a display arranged to display a display view with a plurality of displayed items; and a theme handler arranged to arrange said display view according to a theme comprising a fashion indicator, wherein the arrangement of said display view comprises provision of a visual effect illustrating said fashion indicator.

The apparatus may further comprise a receiver arranged to receive said theme and a processor arranged to determine parameters from said theme on said visual effects.

The apparatus may further comprise a transmitter for transmitting said theme.

The apparatus may be a mobile communication apparatus, a portable digital assistant, a portable media player, a digital camera, or a cell phone.

According to a fourth aspect of the present invention, there is provided a computer-readable medium having computer-executable components comprising instructions for providing a plurality of items on in a display view; determining a theme comprising a fashion indicator; and providing a visual effect associated with said fashion indicator in said display view.

The computer-readable medium may further comprise instructions for making said visual effect appear according to a predetermined appearing rule; and after said visual effect has been present for a predetermined time, making said visual effect disappear according to a predetermined disappearing rule. The computer-readable medium may further comprise instructions for receiving said theme; and determining parameters from said theme on said visual effects. The computer-readable medium may further comprise instructions for composing said theme. The computer-readable medium may further comprise instructions for transmitting said theme.

According to a fifth aspect of the present invention, there is provided a system comprising an apparatus comprising a display arranged to display a display view with a plurality of displayed items; a theme receiver for receiving a theme comprising a fashion indicator; and a theme handler arranged to arrange said display view according to said theme, wherein the arrangement of said display view comprises provision of a visual effect illustrating said fashion indicator; and a fashion indicator server arranged to provide a theme comprising a fashion indicator, wherein said apparatus is arranged to receive said theme from said fashion indicator server.

The apparatus may be arranged to buy said theme to receive said theme from said fashion indicator server.

The fashion indicator server may be arranged to provide said theme as an advertisement to said apparatus.

The system may be a mobile communication system, and said apparatus may be a mobile communication apparatus.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a flow chart illustrating a method for a user interface;

FIG. 2 is a flow char illustrating provision of the visual effect according to an embodiment of the present invention;

FIG. 3 schematically illustrates functionalities of a user interface;

FIG. 4 schematically shows an apparatus according to an embodiment of the present invention;

FIG. 5 illustrates a system architecture for managing a system according to an embodiment of the present invention;

FIG. 6 is an exemplary display view; and

FIG. 7 illustrates a further example of a display view.

### DETAILED DESCRIPTION OF PREFERRED EMBODIMENTS

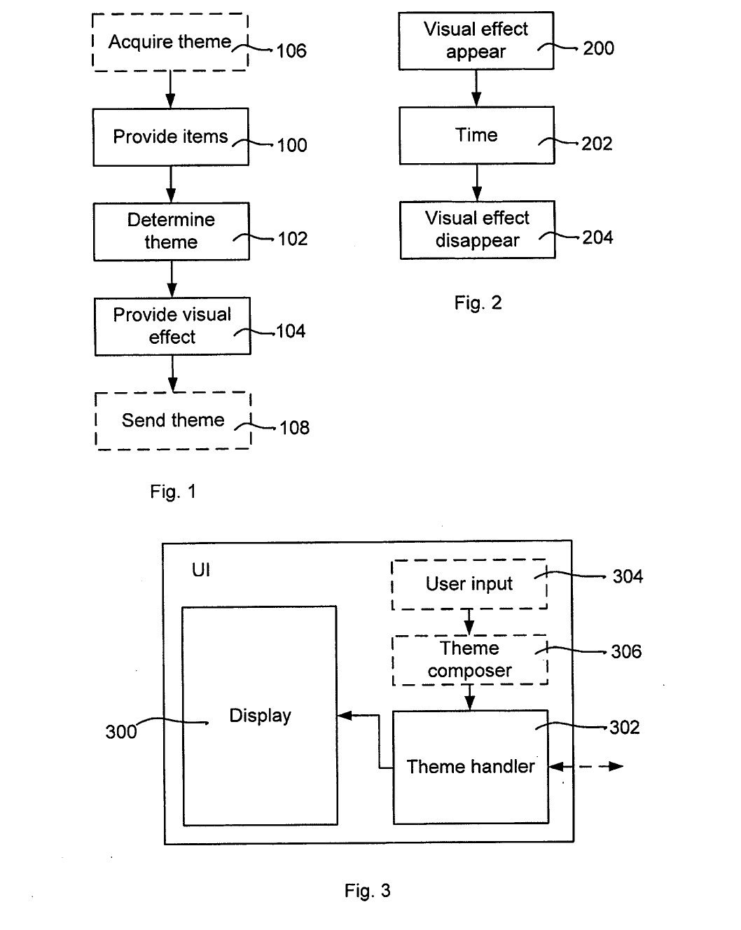

FIG. 1 is a flow chart illustrating a method for a user interface. Items, such as icons, short cuts, list items, etc., are provided 100 in a display view, as will be exemplified with reference to FIG. 6. A theme is also determined 102. Themes are here considered as a recurring contribution to the display view, which contribution is recurring although the display view is changed, e.g. during browsing a menu. Item provision 100 and theme determination 102 can be performed in any order, or in parallel. Then, a visual effect is provided 104 in said display view. The visual effect can be an illustration of a fragrance, as will be exemplified with reference to FIGS. 7 and 8.

Optionally, the theme is acquired 106, if not already present, to be able to determine parameters from the theme on the visual effects. The parameters can define images, add-ons to existing images, image effects, etc. The acquiring can be performed by buying the theme from a theme provider. Alternatively, the theme can be acquired upon buying a perfume, e.g. as a special offer, or be acquired as a commercial advertisement for a perfume. The theme can also be received from another peer entity, e.g. in a message. The theme can also be composed by a user.

Optionally, the theme can be sent 108 to a recipient, e.g. as an add-on feature to a message. This provides for sending a message that is an electronic equivalent to a scented letter.

FIG. 2 is a flow char illustrating provision of the visual effect according to an embodiment of the present invention. First, the visual effect appear 200 on the display view, then it is displayed 202 for a predetermined time, and then, optionally, it disappears 204 from the display view. This can be controlled by the parameters for the theme, which can comprise rules for the effect on how the effect will appear in the display view, for how long time it is to be shown, and how the visual effect is to disappear, if it should, from the display view. The appearing 200 can be in form of a spraying, painting, drawing, fuming, exploding, burning, raining, snowing, growing, etc. effect, where e.g. an image representing a perfume package grows out of the background, and drops representing the perfume is applied with a spraying effect as drops on items in the display view, and the visual effect disappears after a while by the perfume package melts down into the background and the drops vaporizes.

FIG. 3 schematically illustrates a user interface UI comprising a display 300 and a theme handler 302. The display 300 is arranged to display a display view. The theme handler 302 is arranged to provide additional visual effects to the display view according to a theme. The effects can be provided in a separate effect layer, which is provided over items presented in the display view, or in the background of the items. Here, the term ‘layer’ should be construed broadly when considering a three-dimensional user interface, where the effect layer also can be three-dimensional. The theme handler 302 can optionally be arranged to acquire a theme, from which the theme handler 302 determines parameters on the visual effects.

The user interface UI can further comprise input means 304, such as a key pad, a touch screen, a rotatable dial, one or more navigation and soft keys, application specific keys, etc., arranged to enable a user to provide a user input. An optional theme composer 306 can be provided with user inputs from the input means 304 to enable a user to create a theme upon interaction with the user interface UI.

The user interface can be arranged to enable transmission of a theme to another peer entity (not shown). The peer entity can comprise a similar apparatus as the one holding the user interface UI.

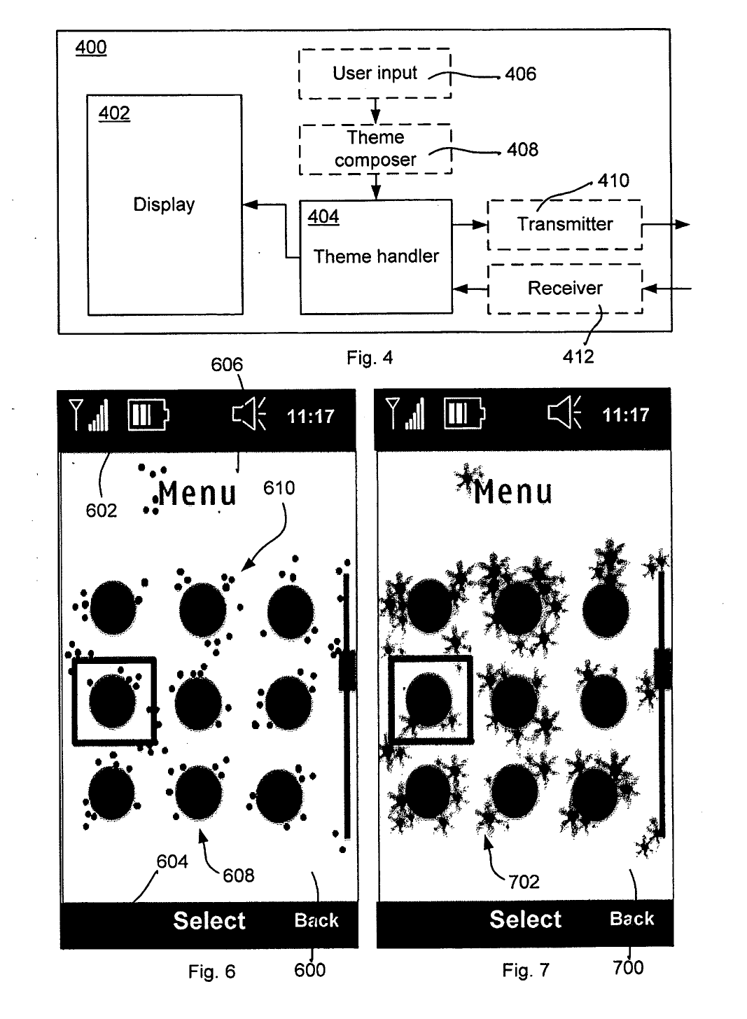

FIG. 4 shows an apparatus 400 according to an embodiment of the present invention. The apparatus 400 can comprise a user interface similar to the one described with reference to FIG. 3.

The apparatus 400 comprises a display 402, a theme handler 404, and a user input 406, and optionally a theme composer 408, a transmitter 410, and a receiver 412.

The display 402 is arranged to display a display view with one or more items, such as normally occurring UI components as icons, scroll bars, list items, etc. The theme handler 404 is arranged to provide additional visual effects to the display view according to a theme. The effects can be provided in a separate effect layer, which is provided over items presented in the display view, or in the background of the items, or the effects can be three-dimensional, i.e. present in any plane with regard to the items. The user input 406 can optionally be used for acquiring a user configured theme by the theme composer 408. The theme can optionally be received by the receiver 412. The theme can optionally also be transmitted by the transmitter 410 to another apparatus, such as directly to a peer entity, to a communication system component, or via a communication system component to a peer entity.

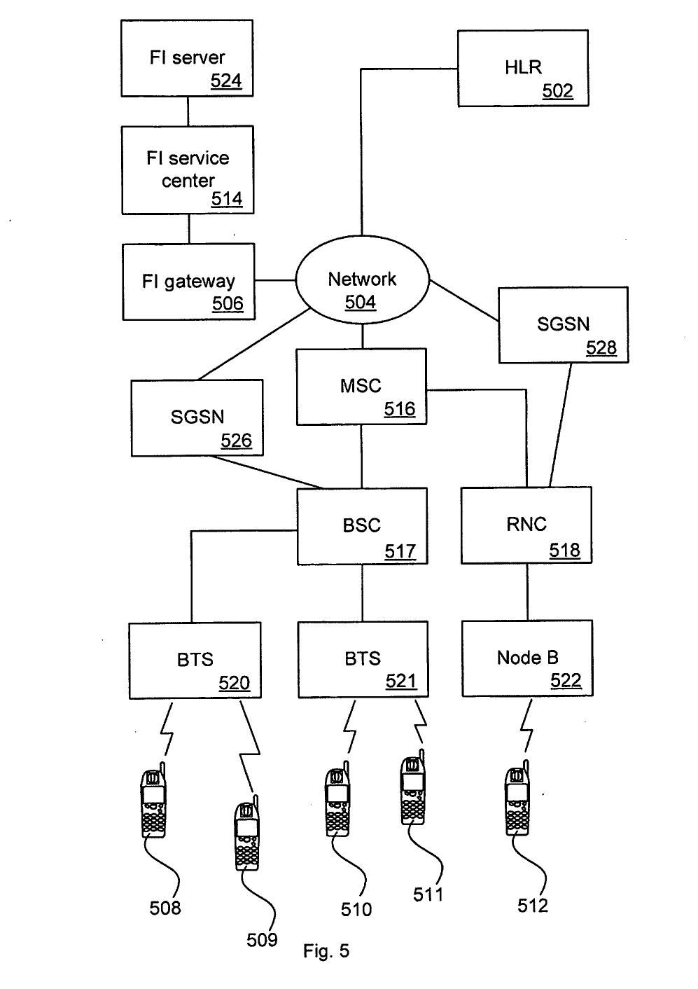

A system architecture for managing a system 500 according to an embodiment of the present invention is shown in FIG. 5. A Home Location Register (HLR) 502 contains a database (not shown) including relevant subscriber information for provision of telecommunication service. A CCITT specified network 504 interconnects the individual parts of the system 500. A fashion indicator (FI) gateway 506 is a switching unit routing a message or a call to a mobile communication apparatus 508-512. The fashion indicator can be a visual fragrance. An FI Service Center 514 (FISC) and the VF gateway 506 handles and routes the FI's between the FISC 514 and the network 504. From the network 504, the FI messages are routed to the mobile communication apparatuses 508-512 via a Mobile Switching Center (MSC) 516 to a Base Station Controller (BSC) 517 and a Base Transceiver Station (BTS) 520, 521, or a Radio Network Controller (RNC) 518 and a Node B 522. Alternatively, the FI messages are routed to the mobile communication apparatuses 508-512 via a Serving GPRS Support Node (SGSN) 526, 528 to the BSC 517 and the BTS 520, 521, or the RNC 518 and the Node B 522, respectively. The BTS 520, 521 or the Node B 522 establish the air connection to the mobile communication apparatuses 508-512.

According to an embodiment of the present invention, a network operator or other third party company handling a fashion indicator server 524 could offer a fashion indicator sharing function between persons not knowing each other. For example a network operator may have a fashion indicator server 524 supporting a feature where the user may send a fashion indicator request from his mobile communication apparatus 508-512 to the fashion indicator server 524 by using a special phone number. This fashion indicator server 524 automatically places people sending a similar request message to the fashion indicator server 524 into “fragrance groups” or “scent rooms”. Whenever a user, being part of such a group, sends a message to the fashion indicator server 524, the fashion indicator server 524 adds the fragrance message ‘on top’ of the previous communication in the group and forwards the up-dated information in an VF message to all the other persons in the group. The fashion indicator server 524 is responsible for the distribution of the VF messages and the distribution lists. The system can also be used for advertising brands, wine makers, night club memberships etc. by providing fashion indicators. The fashion indicator can for example be a visual fragrance, where adverts or offers on virtual fragrances and/or corresponding perfumes are provided, e.g. by push messages.

FIG. 6 is an exemplary display view 600 for illustrating provided effects of the present invention. On top 602 of the display view, status data, such as signal strength, battery status, active options, time of day, etc. can be displayed. At the base 604 of the display view, options associated with soft keys can be displayed. However, this is just illustrative examples not being vital for the present invention, but illustrated for giving an exemplary environment for the invention. In an area 606 for presenting information to a user, one or more items 608 are displayed. In the present example, a menu header, nine menu items, and a scroll bar is presented. One of the menu items is surrounded by a marking indicating a navigation position, which can be controlled by input means of the user interface. The display view 600 further comprises a visual effect layer illustrating a visual fragrance in form of scent bubbles 610.

FIG. 7 illustrates a further example of a display view 700 having similar display items as illustrated in FIG. 6, but with a visual effect layer illustrating the visual fragrance 702 vaporizing.

The invention has mainly been described above with reference to a few embodiments. However, as is readily appreciated by a person skilled in the art, other embodiments than the ones disclosed above are equally possible within the scope of the invention, as defined by the appended patent claims.

1. A method for a user interface, comprising
providing a plurality of items on in a display view;
determining a theme comprising a fashion indicator; and
providing a visual effect associated with said fashion indicator in said display view.

2. The method according to claim 1, wherein said fashion indicator is a visual fragrance.

3. The method according to claim 1, wherein provision of said visual effect comprises providing an effect layer among said items.

4. The method according to claim 1, further comprising
making said visual effect appear according to a predetermined appearing rule; and
after said visual effect has been present for a predetermined time, making said visual effect disappear according to a predetermined disappearing rule.

5. The method according to claim 4, wherein said appearing rule is any of the group comprising spraying, painting, drawing, fuming, exploding, burning, raining, snowing, and growing.

6. The method according to claim 4, wherein said disappearing rule is any of the group comprising melting, splashing, boiling, burning, falling, fading, blowing, vaporizing, erasing, and smudging.

7. The method according to claim 1, wherein said items are any mix from the user interface component group comprising an icon, a list item, a menu item, a file item, a symbol, a help function item, a scroll bar, a selection bar, a selection frame, and a status message item.

8. The method according to claim 1, further comprising acquiring said theme and determining parameters from said theme on said visual effects.

9. The method according to claim 8, wherein acquiring said theme further comprises buying said theme from a theme service provider.

10. The method according to claim 8, wherein acquiring said theme further comprises receiving said theme from another peer entity.

11. The method according to claim 1, further comprising composing said theme.

12. The method according to claim 10, wherein composing said theme comprises setting parameters for said visual effects.

13. The method according to claim 10, further comprising transmitting said theme to another peer entity.

14. A user interface comprising
a display arranged to display a display view with a plurality of displayed items; and
a theme handler arranged to arrange said display view according to a theme comprising a fashion indicator, wherein the arrangement of said display view comprises provision of a visual effect illustrating said fashion indicator.

15. The user interface according to claim 14, wherein said fashion indicator is a visual fragrance.

16. The user interface according to claim 14, wherein provision of said visual effect comprises providing an effect layer among said items.

17. The user interface according to claim 14, wherein said visual effect is arranged to appear according to a predetermined appearing rule, and after said visual effect has been present for a predetermined time, to disappear according to a predetermined disappearing rule.

18. The user interface according to claim 17, wherein said appearing rule is any of the group comprising spraying, painting, drawing, fuming, exploding, burning, raining, snowing, and growing.

19. The user interface according to claim 17, wherein said disappearing rule is any of the group comprising melting, splashing, boiling, burning, falling, fading, blowing, vaporizing, erasing, and smudging.

20. The user interface according to claim 14, wherein said item is any of the group comprising an icon, a list item, a menu item, a file item, a symbol, a help function item, a scroll bar, a selection bar, a selection frame, and a status message item.

21. The user interface according to claim 14, wherein said theme handler is arranged to acquire said theme and determine parameters from said theme on said visual effects.

22. The user interface according to claim 21, wherein said theme is acquired by buying said theme from a theme service provider.

23. The user interface according to claim 21, wherein acquiring said theme further comprises receiving said theme from another peer entity.

24. The user interface according to claim 14, further comprising
input means arranged to receive user input;
a theme composer arranged to generate said theme upon said user input.

25. The user interface according to claim 24, wherein said user input comprises parameters for said visual effects.

26. The user interface according to claim 24, arranged to enable a user to transmit said theme to another peer entity.

27. An apparatus comprising
a display arranged to display a display view with a plurality of displayed items; and
a theme handler arranged to arrange said display view according to a theme comprising a fashion indicator, wherein the arrangement of said display view comprises provision of a visual effect illustrating said fashion indicator.

28. The apparatus according to claim 27, wherein said fashion indicator is a visual fragrance.

29. The apparatus according to claim 27, wherein provision of said visual effect comprises providing an effect layer among said items.

30. The apparatus according to claim 27, wherein said visual effect is arranged to appear according to a predetermined appearing rule, and after said visual effect has been present for a predetermined time, to disappear according to a predetermined disappearing rule.

31. The apparatus according to claim 30, wherein said appearing rule is any of the group comprising spraying, painting, drawing, fuming, exploding, burning, raining, snowing, and growing.

32. The apparatus according to claim 30, wherein said disappearing rule is any of the group comprising melting, splashing, boiling, burning, falling, fading, blowing, vaporizing, erasing, and smudging.

33. The apparatus according to claim 27, wherein said item is any of the group comprising an icon, a list item, a menu item, a file item, a symbol, a help function item, a scroll bar, a selection bar, a selection frame, and a status message item.

34. The apparatus according to claim 27, further comprising a receiver arranged to acquire said theme and a processor arranged to determine parameters from said theme on said visual effects.

35. The apparatus according to claim 34, wherein said theme is acquired by buying said theme from a theme service provider.

36. The apparatus according to claim 34, wherein said theme is acquired by receiving said theme from another peer entity.

37. The apparatus according to claim 27, further comprising
input means arranged to receive user input;
a theme composer arranged to generate said theme upon said user input.

38. The apparatus according to claim 37, wherein said user input comprises parameters for said visual effects.

39. The apparatus according to claim 37, comprising a transmitter for transmitting said theme to another peer entity.

40. The apparatus according to claim 27, belonging to a group comprising a mobile communication apparatus, a portable digital assistant, a portable media player, a digital camera, and a cell phone.

41. A computer-readable medium having computer-executable components comprising instructions for
providing a plurality of items on in a display view;
determining a theme comprising a fashion indicator; and
providing a visual effect associated with said fashion indicator in said display view.

42. The computer-readable medium according to claim 40, further comprising instructions for
making said visual effect appear according to a predetermined appearing rule; and
after said visual effect has been present for a predetermined time, making said visual effect disappear according to a predetermined disappearing rule.

43. The computer-readable medium according to claim 40, further comprising instructions for
receiving said theme; and
determining parameters from said theme on said visual effects.

44. The computer-readable medium according to claim 40, further comprising instructions for composing said theme.

45. The computer-readable medium according to claim 40, further comprising instructions for transmitting said theme to another peer entity.

46. The computer-readable medium according to claim 40, wherein said fashion indicator is a visual fragrance.

47. A system comprising
an apparatus comprising a display arranged to display a display view with a plurality of displayed items; a theme receiver for receiving a theme comprising a fashion indicator; and a theme handler arranged to arrange said display view according to said theme, wherein the arrangement of said display view comprises provision of a visual effect illustrating said fashion indicator; and
a fashion indicator server arranged to provide a theme comprising a fashion indicator,
wherein said apparatus is arranged to receive said theme from said fashion indicator server.

48. The system according to claim 47, wherein said apparatus is arranged to buy said theme to receive said theme from said fashion indicator server.

49. The system according to claim 47, wherein said fashion indicator server is arranged to provide said theme as an advertisement to said apparatus.

50. The system according to claim 47, wherein said system is a mobile communication system, and said apparatus is a mobile communication apparatus.
